(19) United States
(12) Patent Application Publication
(10) Pub. No.: US 2006/0020723 A1
(43) Pub. Date: Jan. 26, 2006

(54) USB hub with wireless communication function

(75) Inventor: Tung Chia-Chun, Taipei City (TW)

Correspondence Address: TROXELL LAW OFFICE PLLC, SUITE 1404, 5205 LEESBURG PIKE, FALLS CHURCH, VA, 22041, US

(73) Assignee: BlueExpert Technology Corp.

(21) Appl. No.: 10/995,361

(22) Filed: Nov. 24, 2004

(30) Foreign Application Priority Data
Jul. 23, 2004 (TW) 93211735

(51) Int. Cl. G06F 13/14

(52) U.S. Cl. 710/62

(57) ABSTRACT

A USB hub with a wireless communication function comprises a USB interface module, a wireless communication interface module, a USB control circuit, and a plurality of digital delay circuits. The USB interface module comprises a USB upstream port and at least one USB downstream port. The USB upstream port and at least one USB downstream port are connected to an external host system and at least an external USB device, respectively. The wireless communication interface module can communicate with an external wireless device through a wireless medium. The USB control circuit connects between the USB interface module and the wireless communication interface module. The control circuit can control the signal transferred between the external host system and the external wireless device, and can control the signal transferred between the external USB devices and the external wireless device. A plurality of digital delay circuits are coupled between the control circuit and the USB interface module, and coupled between the control circuit and the wireless communication interface module for preventing interference of the signals.

### BACKGROUND OF INVENTION

1. Field of the Invention

This invention relates to a USB hub, particularly relates to a USB hub with a wireless communication function.

2. Description of the Prior Art

Nowadays, a variety of portable electronic devices and peripherals are invented and widely used, such as memory cards, card readers, flash disks, portable hard disks, digital cameras, MP3 players, mouse, keyboards, and printers, etc. These devices and computer peripherals usually need to be connected to a host computer for transferring data. Several international communication protocols have been defined for communication among various peripherals. Currently, the universal serial bus (USB) is the most common communication protocol.

Sometimes, it is inconvenient because there is limited number of the USB ports in a host system. For example, there are usually only two USB ports in a Notebook. If one of the two USB ports is connected to the USB Dongle, only one USB port is spared for other device. Therefore, finding a method to solve this problem is important.

A prior art wireless local area network (LAN) switch which communicates with a personal computer (PC) via a USB interface has been disclosed. The wireless LAN switch includes a USB port for connection with the personal computer, a wireless transceiver, and a plurality of network communication ports. The wireless transceiver of the wireless LAN switch is for wireless communications under LAN only. In addition, the communication ports of the wireless LAN switch are all LAN ports too (for example: RJ45 ports). Therefore, The wireless LAN switch of prior art did not disclose the techniques or the characteristics of the present invention.

The U.S. Pat. No. 5,890,015 has disclosed a USB system that includes a first host controller. In the U.S. Pat. No. 5,890,015, a hub is coupled to the first host controller. However, in this U.S. Pat. No. 5,890,015, the USB system and the wireless host are two separated devices, which is different from the technical characteristics of the present invention.

The U.S. Pat. No. 6,725,302 and U.S. Pat. No. 6,603,744 have disclosed some wireless USB hubs. Those techniques are different from the technical characteristics of the present invention.

### SUMMARY OF INVENTION

It is therefore an objective of the present invention to provide a USB hub with a wireless communication function which combines the conventional USB HUB and the conventional USB Dongle into a single USB device and improves the convenience for users.

It is another objective of the present invention to provide a USB hub with a wireless communication function that can reduce the interference among the external USB devices connected to the USB ports, and between the external wireless devices communicated with the wireless interface module through digital delayed circuits.

According to the present invention, a USB hub with a wireless communication function is provided. The USB hub includes a USB interface module having a USB upstream port and at least one USB downstream port for connecting to an external host system and at least one external USB device, respectively; a wireless interface module for transferring a wireless signal to/from an external wireless device through a wireless communication medium; and a control circuit, connected to the USB interface module and the wireless interface module, for transferring a digital signal between the external host system and at least one external USB device, and for transferring the wireless signal between the external host system and the external wireless device.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

The details of the present invention will be more readily understood from a detailed description of the preferred embodiments taken in conjunction with the following figures.

FIG. 1 shows an embodiment of the USB hub with a wireless communication function 10 of the present invention for use with various external USB devices;

FIG. 2 shows the block diagram of the embodiment of the USB hub with a wireless communication function 10 of the present invention;

FIG. 3 shows a detailed circuit of the control circuit 13 of the USB hub 10 according to the embodiment of the present invention;

FIG. 4 shows a detailed circuit of the digital wireless/USB communication circuit 121 of the USB hub 10 according to the embodiment of the present invention; and

FIG. 5 shows a detailed circuit of the USB interface module 11 of the USB hub 10 according to the embodiment of the present invention.

### DETAILED DESCRIPTION

The USB hub with a wireless communication function of this invention combines the conventional USB HUB and the conventional USB Dongle into a single USB apparatus. In additions, the USB hub of this invention utilizes the digital delayed circuits to prevent the interference among the external USB devices connected to the USB ports and the external wireless devices communicated with the wireless communication interface module of the USB hub of the present invention. Therefore, it will be convenient for users and fewer USB ports of the host computer are occupied.

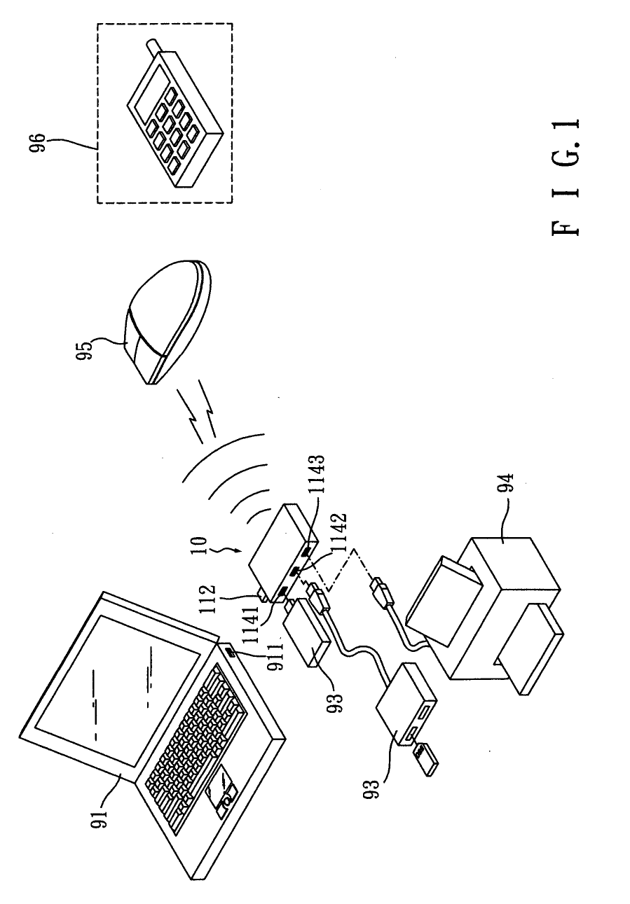

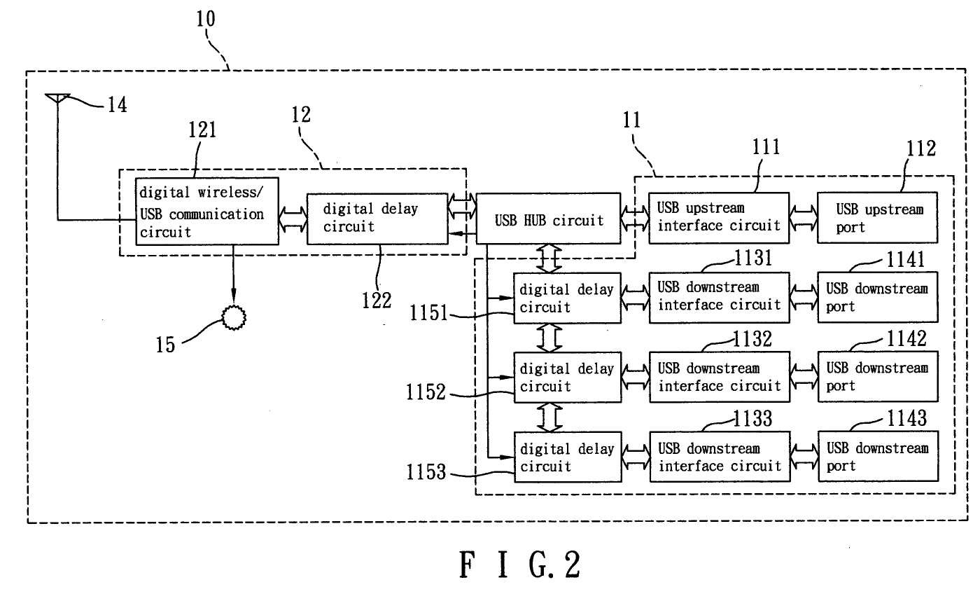

Please refer to FIG. 1 and FIG. 2. FIG. 1 shows an embodiment of the USB hub with a wireless communication function 10 of the present invention for use with various external USB devices. FIG. 2 shows the block diagram of the embodiment of the USB hub with a wireless communication function 10 of the present invention.

As shown in FIG. 1 and FIG. 2, the USB hub with a wireless communication function 10 of the present invention comprises a USB interface module 11, a wireless communication interface module 12; a control circuit 13 connected between the USB interface module 11 and the wireless communication interface module 12; an antenna 14 connected to the wireless communication interface module 12; and a LED 15 connected to the wireless communication interface module 12.

The USB interface module 11 comprises a USB upstream interface circuit 111; a USB upstream port 112; a plurality of USB downstream interface circuits 1131, 1132, and 1133; a plurality of USB downstream ports 1141, 1142, and 1143; and a plurality of the second digital delay circuits 1151, 1152, and 1153. The USB upstream interface circuit 111 is connected between the USB upstream port 112 and the control circuit 13. The USB upstream port 112 can connect to a host system 91 which has a USB host controller. The host system 91 can be a notebook, a desktop computer, a PDA, etc. The second digital delay circuits 1151, 1152, and 1153 are connected to the control circuit 13. The USB downstream interface circuits 1131, 1132, and 1133 are connected between the second digital delay circuits 1151, 1152, and 1153 to the USB downstream ports 1141, 1142, and 1143, respectively. Each of the USB downstream ports 1141, 1142, and 1143 can be connected to the external USB devices 92, 93, and 94, respectively. The external USB devices can be USB flash disk 92, card reader 93, USB printer 94, USB wireless mouse, USB external hard disk, USB external CD ROM, USB scanner, digital camera, cell phone, and another USB hub. Through the control circuit 13, the host system 91 can utilize the USB downstream ports 1141, 1142, and 1143 to connect to a plurality of external USB devices 92, 93, and 94, respectively.

The host system 91 can communicate with the external USB devices 92, 93, and 94 through the USB hub 10 of the present invention. The external USB devices 92, 93 and 94 cannot communicate with each other through the control circuit 13 of the USB hub 10 of the present invention. Each of the second delay circuits 1151, 1152 and 1153 delays the communication between each of the USB downstream interface circuits 1131, 1132, and 1133 and the control circuit 13 with a second predetermined time interval T1, T2, and T3, respectively. The second predetermined time intervals T1, T2, and T3 are not the same to avoid the interference of the external USB devices while the external USB devices 92, 93, and 94 communicate with the host system 91, respectively.

The wireless communication interface module 12 comprises a digital wireless/USB communication circuit 121 and a first digital delay circuit 122. The wireless interface communication module 12 can communicate with an external wireless device 95 and/or an external wireless device 96 via a wireless medium. The external wireless devices 95, 96 can be the wireless mouse 95, cellular phone 96, PDA, or another conventional wireless Dongle.

An antenna 14 is connected to the digital wireless/USB communication circuit 121 for receiving and transmitting a wireless signal. The digital wireless/USB communication circuit 121 is for converting the received signal from the antenna 14 into a digital signal with USB format and transferring the digital signal to the control circuit 13, and converting the digital signal from the control circuit 13 into a wireless signal and transmitting the wireless signal to the external wireless device 95 through the antenna 14. The LED 15, which is connected to the digital wireless/USB communication circuit 121, is for representing the status of the wireless communication. In this embodiment, the protocol of the wireless signal is compliant with one of the specifications of wireless local area network (VVLAN), radio frequency (RF), Bluetooth, and infrared (IR).

The first digital delay circuit 122 connects between the digital wireless/USB communication circuit 121 and the control circuit 13. The first digital delay circuit 121 delays the digital signal communicating between the digital wireless USB communication circuit 121 and the control circuit 13 with a first predetermined time interval T4. The predetermined time interval T1, T2, T3, and T4 are not the same. The host system 91 can communicate with each of the external USB devices 92, 93, 94 and the external wireless device 95 through the USB Hub 10 of the present invention. Therefore, the control circuit 13 controls the communication between the host system 91 and the external wireless device 95, and also controls the communication between the host system 91 and each of the external USB devices. The first and second digital delay circuits 122, 1151, 1152, and 1153 are for preventing the interference of communication of the devices. The USB hub 10 of the present invention, which combines the conventional USB Hub with the conventional USB Dongle into a single device, is for users' convenience and decreasing the occupying of the USB port 911 of the host system 91.

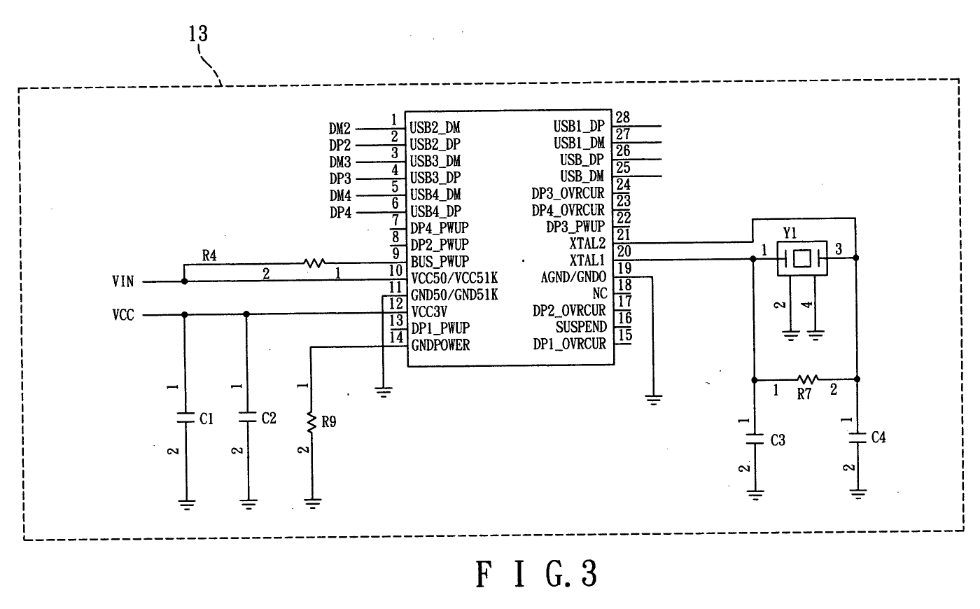

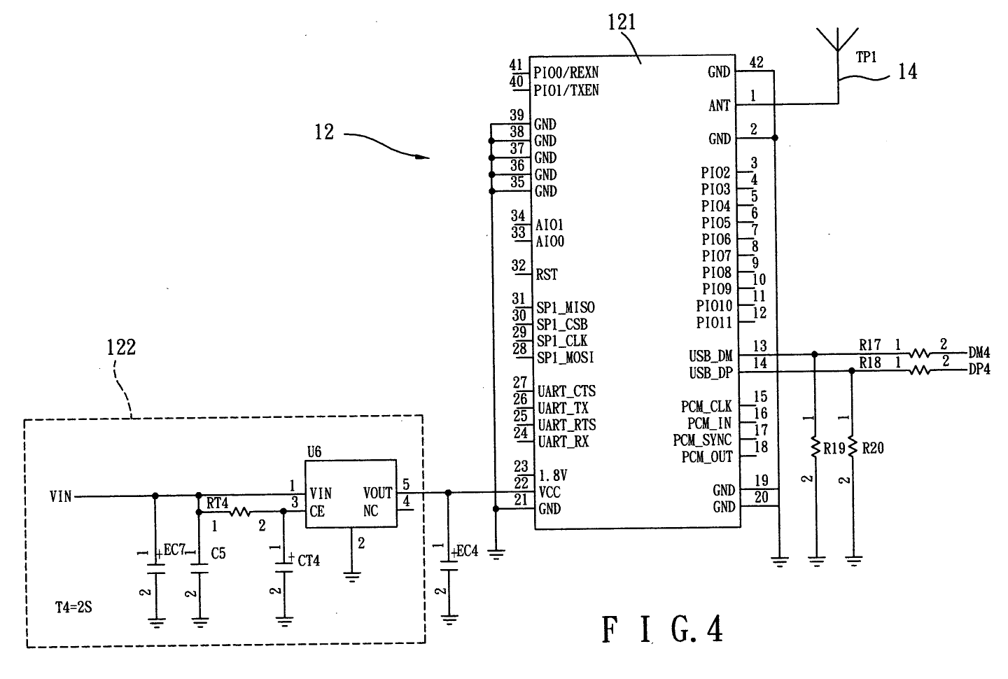

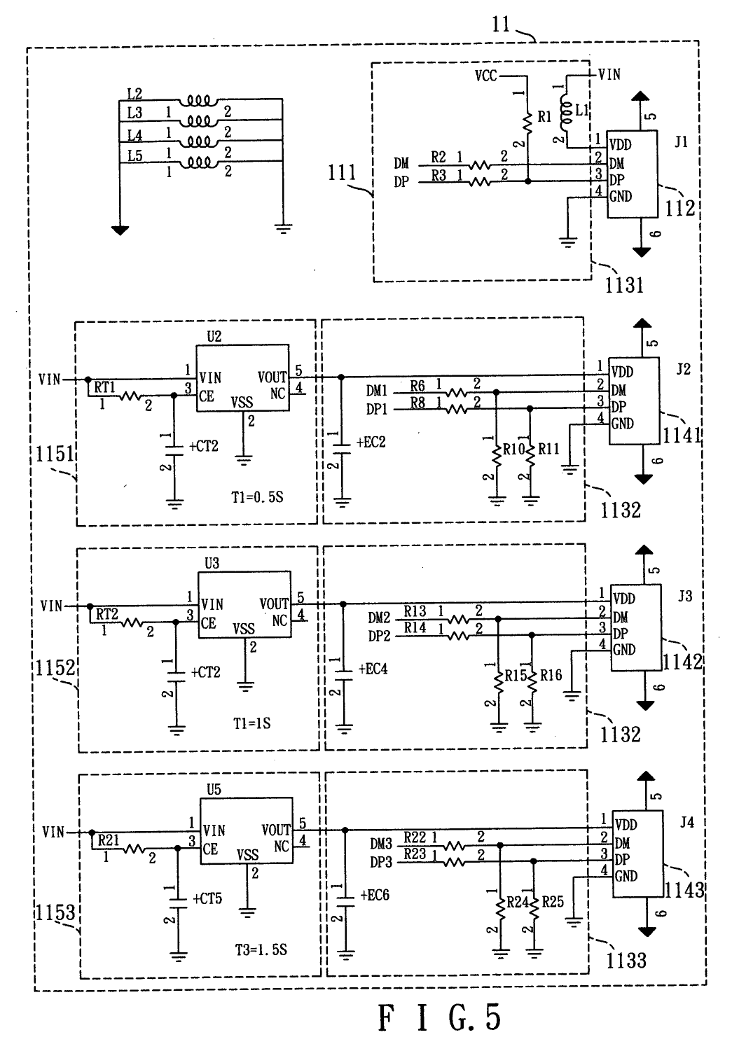

Please refer to FIG. 3, FIG. 4, and FIG. 5. FIG. 3 shows a detailed circuit of the control circuit 13 of the USB hub 10 according to the embodiment of the present invention. FIG. 4 shows a detailed circuit of the digital wireless/USB communication circuit 121 of the USB hub 10 according to the embodiment of the present invention. FIG. 5 shows a detailed circuit of the USB interface module 11 of the USB hub 10 according to the embodiment of the present invention.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. A universal serial bus (USB) hub with a wireless communication function, comprising:
a USB interface module having a USB upstream port and at least one USB downstream port for connecting to an external host system and at least one external USB device, respectively;
a wireless interface module for transferring a wireless signal to/from an external wireless device through a wireless communication medium; and
a control circuit, connected to the USB interface module and the wireless interface module, for transferring a first signal between the external host system and at least one external USB device and transferring a second signal between the external host system and the external wireless device.

2. The universal serial bus hub as set forth in claim 1, wherein the format of the wireless signal is comply with a specification choosing from:
wireless local area network (WLAN), radio frequency (RF), Bluetooth, and infrared (IR).

3. The universal serial bus hub with a wireless communication function as set forth in claim 1, further comprising an antenna, coupled to the wireless interface module, utilized for receiving and transmitting a wireless signal from/to the external wireless device.

4. The universal serial bus hub with a wireless communication function as set forth in claim 3, wherein the wireless interface module further comprises a digital wireless/USB communication circuit utilized for converting the wireless signal from the external wireless device into a digital USB signal, and transferring the digital USB signal to the control circuit; the digital wireless/USB communication circuit utilized for converting the digital USB signal from the external host system or the external USB device into the wireless signal, and transferring the wireless signal to the external wireless device.

5. The universal serial bus hub with a wireless communication function as set forth in claim 4, wherein the wireless interface module further comprises a first digital delay circuit, coupled between the control circuit and the digital wireless/USB communication circuit, for delaying a first predetermined time interval of the signal transferred between the control circuit and the digital wireless/USB communication circuit.

6. The universal serial bus hub with a wireless communication function as set forth in claim 1, further comprising an indicated LED coupled to the digital wireless/USB communication circuit for indicating the state of the wireless communication.

7. The universal serial bus hub with a wireless communication function as set forth in claim 1, wherein the USB interface module further comprises a USB upstream interface circuit connected between the USB upstream port and the control circuit, and at least one USB downstream interface circuit connected between the USB downstream port and the control circuit.

8. The universal serial bus hub with a wireless communication function as set forth in claim 7, wherein the USB interface module further comprises a second digital delay circuit, connected between the USB downstream interface circuit and the control circuit, for delaying a second predetermined time interval of the signal transferred between the USB downstream interface circuit and the control circuit.

9. The universal serial bus hub with a wireless communication function as set forth in claim 1, wherein the external host system communicates with the external USB device through the USB upstream port and the USB downstream port, and communicates with the external wireless device through the USB upstream port and the wireless interface module; wherein the external USB device does not directly communicate with the external wireless device through the USB downstream port and the wireless interface module.

10. A universal serial bus (USB) hub with a wireless communication function, comprising:
a USB upstream interface;
a USB control circuit coupled to the USB upstream interface;
a digital USB/wireless communication circuit, connected to the USB control circuit, utilized for transmitting a wireless signal, and transferring a first digital USB signal to or from the USB upstream interface through the USB control circuit;
at least one USB downstream interface, coupled to the USB control circuit, for transferring a second digital USB signal to or from the USB upstream interface through the USB control circuit.
a first digital delay circuit, coupled between the digital USB/wireless communication circuit and the USB control circuit, for delaying a first predetermined time interval of the first digital USB signal transferred between the between the digital USB/wireless communication circuit and the USB control circuit; and
a second digital delay circuit, coupled between the USB downstream interface and the USB control circuit, for delaying a second predetermined time interval of the second digital USB signal transferred between the between the USB downstream interface and the USB control circuit;
wherein the first and the second predetermined time interval are not the same so as to avoid the occurrence of interference between the first digital USB signal and the second digital USB signal.

11. The universal serial bus hub with a wireless communication function as set forth in claim 11, further comprising:
a USB upstream port, connected to the USB upstream interface, utilized for connecting to an external host device;
at least one USB downstream port, connected to the USB downstream interface, utilized for connecting to an external USB device; and
an antenna, connected to the digital USB/wireless communication circuit, utilized for receiving/transmitting the wireless signal from/to an external wireless device;
wherein the USB control circuit controls the wireless signal transferred between the external host device and the external wireless device and the digital USB signal transferred between the external host device and the external USB device.

12. The universal serial bus hub with a wireless communication function as set forth in claim 11, wherein the external host device communicates with the external USB device through the USB upstream port and the USB downstream port, and communicates with the external wireless device through the USB upstream port and the wireless interface module;
wherein the external USB device does not directly communicate with the external wireless device through the USB downstream port and the wireless interface module.

13. The universal serial bus hub with a wireless communication function as set forth in claim 11, wherein the format of the wireless signal is comply with a specification choosing from: wireless local area network (WLAN), radio frequency (RF), bluetooth, and infrared (IR).

14. The universal serial bus hub with a wireless communication function as set forth in claim 10, wherein the digital USB/wireless communication circuit converts the wireless signal from the external wireless device into the digital USB signal for inputting into the USB control circuit, and converts the digital USB signal from the external host device into the wireless signal for transmitting to the external wireless device.

15. The universal serial bus hub with a wireless communication function as set forth in claim 10, further comprising an indicated LED coupled to the digital USB/wireless communication circuit for indicating a status of the wireless communication.

16. The universal serial bus hub with a wireless communication function as set forth in claim 10, wherein the number of the USB downstream interface is more than two, the USB downstream interfaces are connected to the corresponding second digital delay circuits, respectively, and the predetermined delay time intervals of the digital delay circuits are not the same.
